(19) United States
(12) Patent Application Publication
(10) Pub. No.: US 2020/0014150 A1
(43) Pub. Date: Jan. 9, 2020

(54) HIGH-SPEED CONNECTOR ASSEMBLY, SOCKET CONNECTOR AND SOCKET TERMINAL

(71) Applicant: OUPIIN ELECTRONIC (KUNSHAN) CO., LTD., Jiangsu province (CN)

(72) Inventor: Hsin Chih CHEN, Jiangsu province (CN)

(21) Appl. No.: 16/411,501

(22) Filed: May 14, 2019

(30) Foreign Application Priority Data
Jul. 5, 2018 (CN) 201810730762.5

(51) Int. Cl. H01R 13/6471; H01R 13/514

(52) U.S. Cl. CPC H01R 13/6471; H01R 13/514

(57) ABSTRACT

A high-speed connector assembly, a socket connector and a socket terminal are disclosed in the present invention. The socket terminal includes a first branch and a second branch, which are independent, noncoplanar, unequal-height and unequal-length. The first branch forms an arcuate part perpendicular to one wide surface of one corresponding plug terminal for being used to electrically contact with the wide surface. The second branch forms a protrusion part perpendicular to one narrow surface of the plug terminal for being used to electrically contact with the narrow surface. By this double-contact design, the high-speed connector assembly has a greater signal throughput for high-speed signals, and can construct a reliable mechanical connection between the socket terminal and the plug terminal, and has an excellent electrical contact performance.

### BACKGROUND OF THE INVENTION

### 1. Field of the Invention

The present invention relates to a connector technology, and more particularly to a high-speed connector assembly, a socket connector and a socket terminal, wherein the socket terminal has two independent, noncoplanar, unequal-height and unequal-length branches.

### 2. Description of the Prior Art

A backplane connector is widely used in communication technology. It is one common connector, which is used for large scale communication equipment, a super high performance server, a huge computer, an industrial computer and a high-end storage device. The backplane connectors are to connect daughter cards and backplanes. The daughter card and the backplane are vertical at 90 degrees.

With the continuous improvement of communication technology, the requirement for data transmission rate is also getting higher and higher. A high-speed backplane is a part of a typical electronic system that connects each module physically. A complex system relies on connection lines, routes and connectors of the backplane to process a large number of high-speed data streams. A high-speed backplane connector plays an important role in the communication between multiple backplane modules, so it is necessary to increase the technical research of the backplane connector to meet the signal rate requirements of high-speed communication systems.

The theme of this research is how to ensure the reliability and excellent electrical contact performance of mechanical connection between a high-speed backplane socket connector and a plug connector.

### BRIEF SUMMARY OF THE INVENTION

A first object of the present invention is to provide a high-speed connector assembly, which can construct a reliable mechanical connection and a stable signal transmission, can reduce crosstalk and loss, and can provide a greater signal throughput for high-speed signals.

A second object of the present invention is to provide a socket connector, which can form a special electrical contact mode with a plug connector to construct a reliable mechanical connection and a stable signal transmission, while reducing crosstalk and loss, so as to provide a greater signal throughput for high-speed signals.

A third object of the present invention is to provide a socket terminal, which can construct a reliable mechanical connection and ensure an excellent electrical contact performance between the socket terminal and a corresponding plug terminal, so as to provide a greater signal throughput for high-speed signals.

Other objects and advantages of the present invention may be further understood from the technical features disclosed by the present invention.

To achieve the aforementioned object or other objects of the present invention, the present invention adopts the following technical solution.

The present invention provides a high-speed connector assembly, comprising a plug connector and a socket connector. The plug connector includes multiple plug terminals, each of which is straight and has a mating end and a tail end. A cross section of the mating end is rectangular and the mating end has two parallel wide surfaces and two parallel narrow surfaces. The socket connector includes an insulating cover and multiple terminal modules arranged side by side and retained in the insulating cover. Each terminal module includes at least an insulating frame and a socket terminal group retained in the insulating frame. The socket terminal group includes multiple pairs of differential signal socket terminals and multiple grounding terminals. Each of the differential signal socket terminals has an L-type body, a front mating portion being bent from one end of the body toward one side of the body and extending forward, and a bottom mounting portion extending downward from the other end of the body. The front mating portion includes a first branch and a second branch, which are independent, noncoplanar, unequal-height and unequal-length. The first branch forms an arcuate part perpendicular to one wide surface of one corresponding plug terminal. The second branch forms a protrusion part perpendicular to one narrow surface of the plug terminal. A length of the second branch is greater than that of the first branch. The protrusion part is located in front of the arcuate part. When the socket connector and the plug connector are mating, the protrusion part first contacts with the narrow surface of the plug terminal, slides along the narrow surface toward the tail end, and finally rests on the narrow surface. The arcuate part contacts with the wide surface of the plug terminal, slides along the narrow surface toward the tail end, and finally rests on the narrow surface.

In one embodiment, the L-type body and the bottom mounting portion of the differential signal socket terminal are located in a first vertical plane, but the front mating portion leaves the first vertical plane.

In one embodiment, the first branch is located in a second vertical plane and extends horizontally and straight ahead; and the arcuate part is located on a front end of the first branch, is formed by bending and is perpendicular to the second vertical plane; and the second branch is located in a third vertical plane and extends horizontally and straight ahead; and the protrusion part is located on a front end of the second branch, is formed by stamping and is perpendicular to the third vertical plane.

In one embodiment, the second vertical plane is parallel to the first and third vertical planes, which are parallel or overlap.

In one embodiment, each pair of differential signal socket terminals includes two differential signal socket terminals, the front mating portions of which are symmetrical; one grounding terminal is arranged above and below each pair of differential signal socket terminals; and a width of each grounding terminal is greater than that of each differential signal socket terminal.

The present invention further provides a socket connector, which comprises an insulating cover and multiple terminal modules being arranged side by side and retained in the insulating cover. Each terminal module includes at least an insulating frame and a socket terminal group retained in the insulating frame. The socket terminal group includes multiple pairs of differential signal socket terminals and multiple grounding terminals. Each of the differential signal socket terminals has an L-type body located in a first vertical plane, a front mating portion being bent from one end of the body toward one side of the body and extending forward, and a bottom mounting portion extending downward from the other end of the body. The bottom mounting portion is located in the first vertical plane, and the front mating portion leaves the first vertical plane. The front mating portion includes a first branch and a second branch, which are independent, noncoplanar, unequal-height and unequal-length. The first branch is located in a second vertical plane parallel to the first vertical plane and extends horizontally forward. The first branch has an arcuate part, which is formed by bending and is perpendicular to the second vertical plane, on a front end of the first branch. The second branch is located in a third vertical plane parallel to the second vertical plane extending horizontally forward. The second branch has a protrusion part, which is formed by stamping and is located in the third vertical plane, on a front end of the second branch. When the socket connector is engaged with a plug connector, the arcuate part and the protrusion part can electrically contact with one wide surface and one narrow surface of a corresponding plug terminal, respectively.

In one embodiment, a length of the second branch is greater than that of the first branch, and the protrusion part is located in front of the arcuate part.

In one embodiment, each pair of differential signal socket terminals includes two differential signal socket terminals, the front mating portions of which are symmetrical; one grounding terminal is arranged above and below each pair of differential signal socket terminals; and a width of each grounding terminal is greater than that of each differential signal socket terminal.

In one embodiment, the first vertical plane and the third vertical plane are parallel or overlap.

The present invention further provides a socket terminal, which comprises an L-type body being located in a first vertical plane, a front mating portion being bent from one end of the body toward one side of the body and extending forward, and a bottom mounting portion extending downward from the other end of the body. The bottom mounting portion is located in the first vertical plane, and the front mating portion leaves the first vertical plane. The front mating portion includes a first branch and a second branch, which are independent, noncoplanar, unequal-height and unequal-length. The first branch is located in a second vertical plane parallel to the first vertical plane. The first branch has an arcuate part, which is formed by bending and is perpendicular to the second vertical plane for being used to electrically contact with one wide surface of a plug terminal. The second branch is located in a third vertical plane parallel to the second vertical plane. The second branch has a protrusion part, which is formed by stamping and is located in the third vertical plane for being used to electrically contact with one narrow surface of the plug terminal.

In one embodiment, a length of the second branch is greater than that of the first branch, and the protrusion part is located in front of the arcuate part.

In one embodiment, the first vertical plane and the third vertical plane are parallel or overlap.

In comparison with the prior art, the socket terminal of the present invention disposes two independent, noncoplanar, unequal-height and unequal-length branches to form double contacts with two different surfaces of the corresponding plug terminal, thereby improving the signal throughput of the high-speed connector assembly, constructing a reliable mechanical connection between the socket terminal and the plug terminal, and having an excellent electrical contact performance between the both. Meanwhile, when the transmission rate of the high speed signal is greater than 25 Gbps-40 Gbps, the high-speed connector assembly of the present invention can restrain a short pile effect, reduce crosstalk and loss and ensure more stable and reliable signal transmission quality.

### BRIEF DESCRIPTION OF THE DRAWINGS

FIG. 1 is a perspective view of a high-speed connector assembly of the present invention;

FIG. 2 is a disassembled view of the high-speed connector assembly of the present invention;

FIG. 3 is a disassembled view of the high-speed connector assembly along another direction;

FIG. 4 is a perspective view of one of socket terminal groups of a socket connector of the present invention;

FIG. 5 is a plan view of the socket terminal group shown in FIG. 4;

FIG. 6 is a perspective view of one pair of differential signal socket terminals in the socket terminal group shown in FIG. 4;

FIG. 7 is a plan view of one terminal in the pair of differential signal socket terminals shown in FIG. 6;

FIG. 8 is a simulation view showing that the pair of differential signal socket terminals of FIG. 6 electrically contact with one pair of plug terminals; and

FIG. 9 is a simulation plan view showing that the pair of differential signal socket terminals of FIG. 6 electrically contact with the pair of plug terminals.

### DETAILED DESCRIPTION OF THE PREFERRED EMBODIMENTS

The following description of every embodiment with reference to the accompanying drawings is used to exemplify a specific embodiment, which may be carried out in the present invention. Directional terms mentioned in the present invention, such as “up”, “down”, “front”, “back”, “left”, “right”, “top”, “bottom” “above”, “below” etc., are only used with reference to the orientation of the accompanying drawings. Therefore, the used directional terms are intended to illustrate, but not to limit, the present invention.

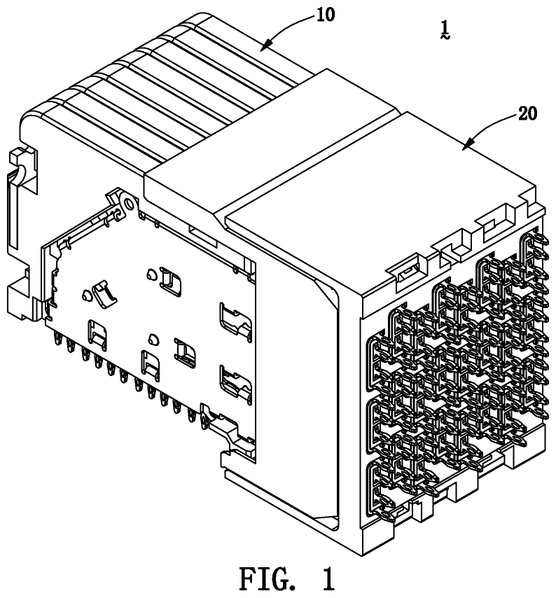

Please refer to FIGS. 1 to 3, a high-speed connector assembly 1 of the present invention includes a socket connector 10 and a plug connector 20. The socket connector 10 may be a right-angle connector, the mating direction of which is parallel to a horizontal circuit board (not shown), on which the socket connector 10 is mounted. The plug connector 20 may be a vertical end connector, the mating direction of which is perpendicular to a vertical circuit board (not shown), on which the plug connector 20 is mounted.

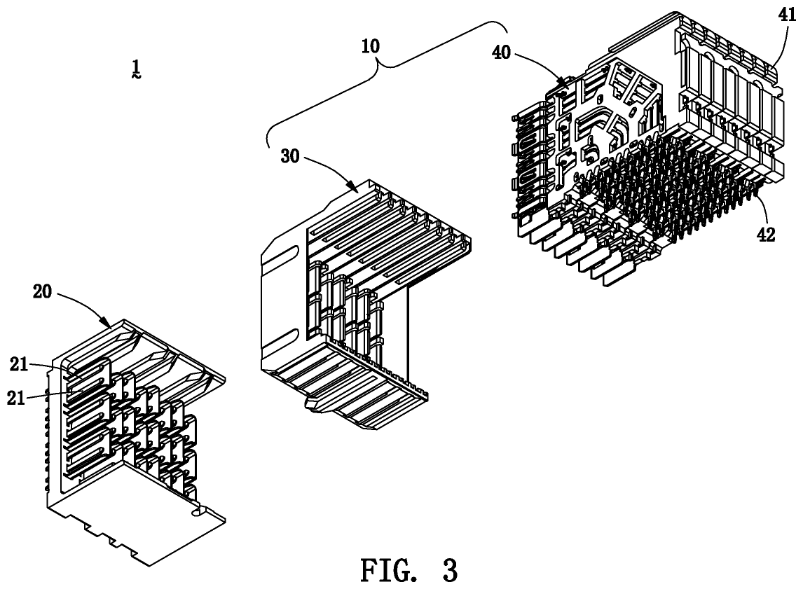

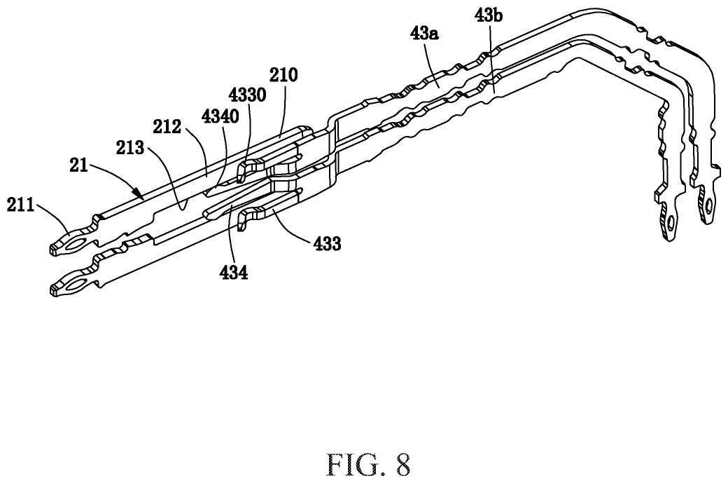

Referring to FIG. 3, the plug connector 20 has multiple differential signal plug terminals 21. Referring to FIG. 8, each plug terminal 21 is straight, and has a mating end 210 and a tail end 211. The mating end 210 has a rectangular cross section, and has two parallel wide surfaces 212 and two parallel narrow surfaces 213. The two wide surfaces 212 are perpendicular to the two narrow surfaces 213. It should be noted that, the two narrow surfaces 213 are actually side edges of the mating end 210, or called cut edges.

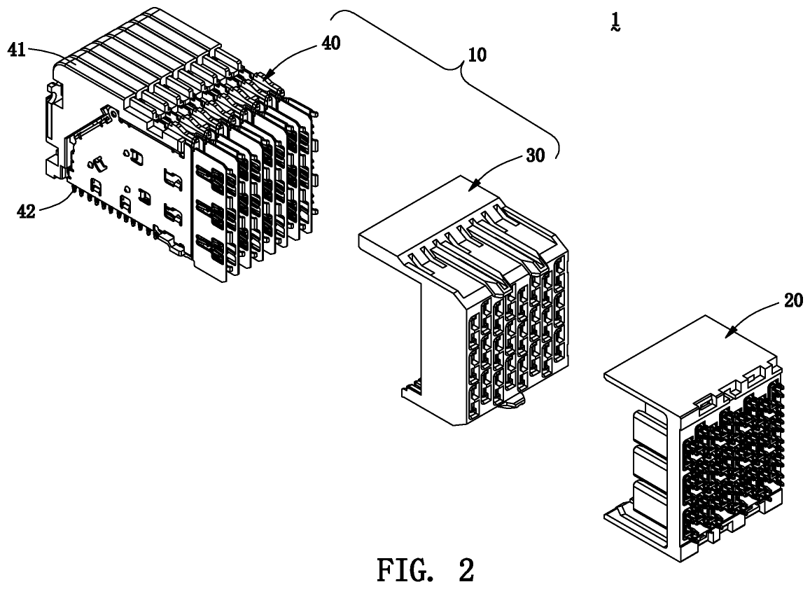

Referring to FIGS. 2 and 3, the socket connector 10 includes an insulating cover 30 and multiple terminal modules 40 mounted in the insulating cover 30 and arranged side by side from left to right.

Referring to FIGS. 2 and 3, each terminal module 40 includes at least an insulating frame 41, and a socket terminal group 42 retained in the insulating frame 41.

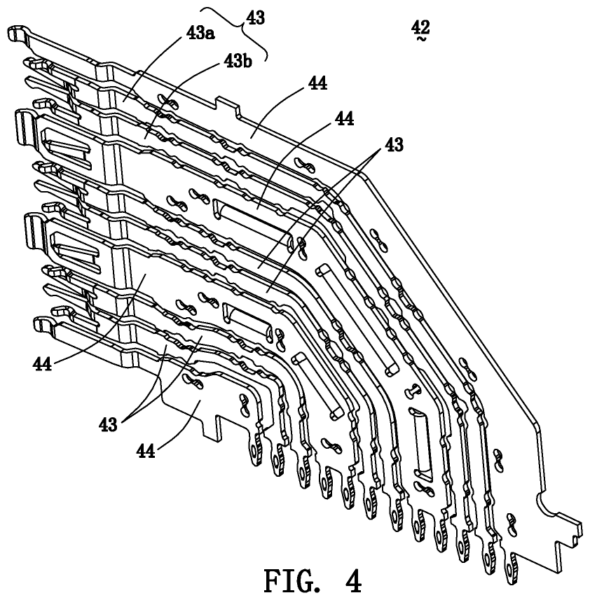

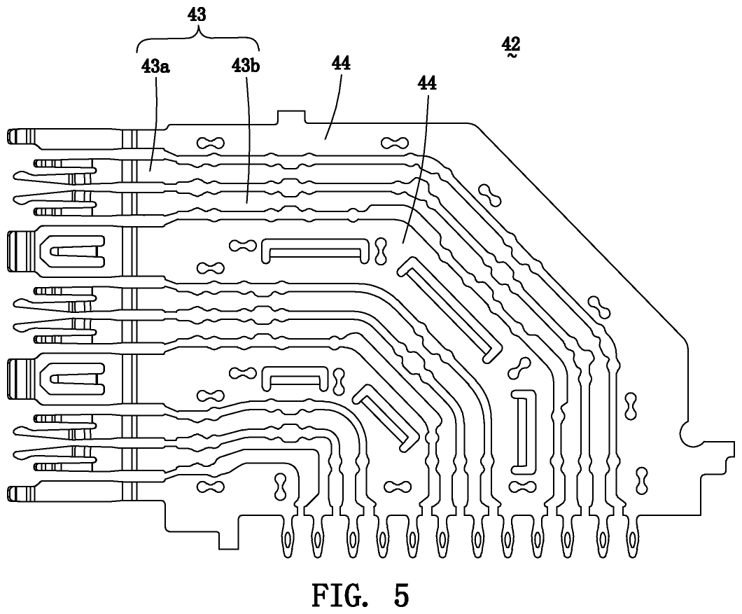

Referring to FIGS. 4 and 5, the socket terminal group 42 includes multiple pairs of differential signal socket terminals 43 and multiple grounding terminals 44. There is one grounding terminal 44 arranged above and below each pair of differential signal socket terminals 43. In the embodiment, each pair of differential signal socket terminals 43 includes two differential signal socket terminals 43a, 43b, and the width of each grounding terminal 44 is greater than that of each differential signal socket terminal 43.

The structure of the socket terminal will be described in detail with one pair of differential signal socket terminals 43 as an example.

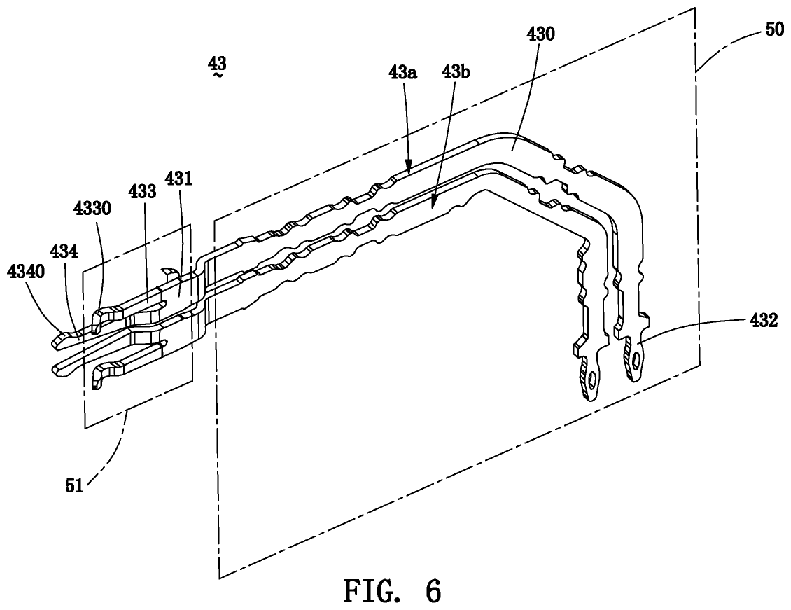

Referring to FIG. 6, each pair of differential signal socket terminals 43 includes two differential signal socket terminals 43a, 43b. Each differential signal socket terminal 43a (43b) has an L-type body 430 located in a first vertical plane 50, a front mating portion 431 being bent from one end of the body 430 toward one side of the body 430 and extending forward, and a bottom mounting portion 432 extending downward from the other end of the body 430. The bottom mounting portion 432 is located in the first vertical plane 50, but the front mating portion 431 leaves the first vertical plane 50 because of being bent toward one side.

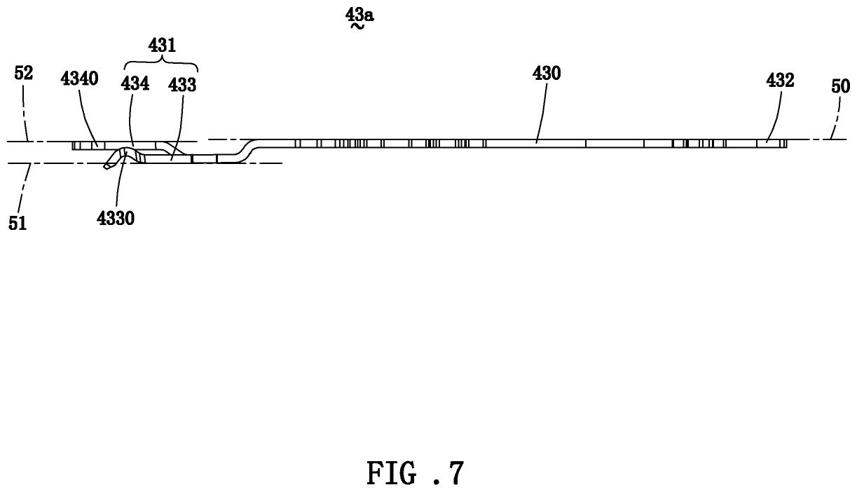

Referring to FIGS. 6 and 7, the front mating portion 431 includes two independent, noncoplanar, unequal-height and unequal-length branches, including a first branch 433 and s second branch 434. The first branch 433 is located in a second vertical plane 51 and extends horizontally and straight ahead. The first branch 433 forms an arcuate part 4330, which is perpendicular to the second vertical plane 51 and is formed by bending, on a front end of the first branch 433. The arcuate part 4330 is used to contact with one wide surface 212 of the plug terminal 21 shown in FIG. 8. In the embodiment, the second vertical plane 51 is parallel to the first vertical plane 50. The second branch 434 is bent toward the first vertical plane 50 and leaves the second vertical plane 51. The second branch 434 is located in a third vertical plane 52 (seen in FIG. 7), and extends horizontally and straight ahead. The second branch 434 forms a protrusion part 4340, which is located in the third vertical plane 52 and is formed by stamping, on a side edge of the second branch 434. The protrusion part 4340 is used to contact with one narrow surface 213 of the plug terminal 21. The second vertical plane 51 is parallel to the third vertical plane 52.

In one embodiment, the third vertical plane 52 is parallel the first vertical plane 50. But in other embodiments, that can be changed according to actual structures. For example, the third vertical plane 52 may overlap with the first vertical plane 50.

Further, referring to FIG. 8, the arcuate part 4330 is perpendicular to the wide surface 212 of the plug terminal 21, and the protrusion part 4340 is perpendicular to the narrow surface 213 of the plug terminal 21. Namely, the arcuate part 4330 protrudes toward the wide surface 212 of the plug terminal 21, when mating, the arcuate part 4330 can electrically contact with the wide surface 212 of the plug terminal 21. The protrusion part 4340 protrudes toward the narrow surface 213 of the plug terminal 21, when mating, the protrusion part 4340 can electrically contact with the narrow surface 213 of the plug terminal 21.

In the embodiment, the arcuate part 4330 is formed by bending, and the protrusion part 4340 is formed by blanking. But both bending and blanking are realized by the same stamping die.

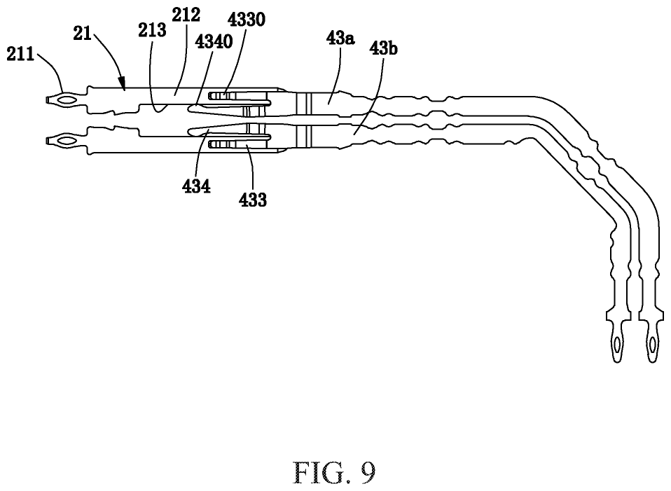

Moreover, referring to FIGS. 8 and 9, a length of the second branch 434 is greater than that of the first branch 433, and the protrusion part 4340 is located in front of the arcuate part 4330, so the protrusion part 4340 is closer to the tail end 211 of the plug terminal 21 than the arcuate part 4330. When mating, the protrusion part 4340 can first contact with the narrow surface 213 of the plug terminal 21, and then the arcuate part 4330 can contact the wide surface 212 of the plug terminal 21. By this design of double contacts, the high-speed connector assembly 1 has a greater signal throughput for high-speed signals, and the socket terminals (namely the two differential signal socket terminals 43a, 43b) forms a reliable mechanical connection with the plug terminal 21, and has an excellent electrical contact performance therebetween. Further, the insertion force of the plug terminal 21 can also be optimized.

Please refer to FIG. 6 again, the first branch 433 and the second branch 434 are unequal-height. Specifically, for one differential signal socket terminal 43a in the pair of differential signal socket terminals 43, the first branch 433 is located above the second branch 434. But for the other differential signal socket terminal 43b in the pair of differential signal socket terminals 43, the first branch 433 is located below the second branch 434. Therefore, the front mating portions 431 of the pair of differential signal socket terminals 43 (43a, 43b) are symmetrical. That is, the front mating portion 431 of one terminal 43a is symmetrical to that of the other terminal 43b.

When the socket connector 10 and the plug connector 20 are electrically mating, referring to FIG. 8, the arcuate part 4330 of the first branch 433 slides along one wide surface 212 of the mating end 210 toward the tail end 211 and finally rests on the wide surface 212; and the protrusion part 4340 of the second branch 434 slides along one narrow surface 213 of the mating end 210 toward the tail end 211 and finally rests on the narrow surface 213. In this connection way, the pair of differential signal socket terminals 43 of the socket connector 10 and one pair of corresponding plug terminals 21 of the plug connector 20 can form an electrical contact therebetween.

As described above, in the present invention, the socket terminal (i.e. a single differential signal socket terminal 43) disposes two independent, noncoplanar, unequal-height and unequal-length branches 433, 434 to form the double contacts with two different surfaces 212, 213 of the corresponding plug terminal 21, thereby improving the signal throughput of the high-speed connector assembly 1, constructing the reliable mechanical connection between the socket terminal and the plug terminal 21, and having the excellent electrical contact performance between the both. Meanwhile, when the transmission rate of the high speed signal is greater than 25 Gbps-40 Gbps, the high-speed connector assembly 1 of the present invention can restrain a short pile effect, reduce crosstalk and loss and ensure more stable and reliable signal transmission quality.

What is claimed is:

1. A high-speed connector assembly, comprising:
a plug connector, including multiple plug terminals, each of which is straight and has a mating end and a tail end; a cross section of the mating end being rectangular and the mating end having two parallel wide surfaces and two parallel narrow surfaces; and
a socket connector, including an insulating cover and multiple terminal modules arranged side by side and retained in the insulating cover; each terminal module including at least an insulating frame and a socket terminal group retained in the insulating frame; the socket terminal group including multiple pairs of differential signal socket terminals and multiple grounding terminals; wherein each of the differential signal socket terminals has an L-type body, a front mating portion being bent from one end of the body toward one side of the body and extending forward, and a bottom mounting portion extending downward from the other end of the body;
wherein the front mating portion includes a first branch and a second branch, which are independent, noncoplanar, unequal-height and unequal-length; the first branch forming an arcuate part perpendicular to one wide surface of one corresponding plug terminal; the second branch forming a protrusion part perpendicular to one narrow surface of the plug terminal; a length of the second branch being greater than that of the first branch; the protrusion part being located in front of the arcuate part;
when the socket connector and the plug connector are mating, the protrusion part first contacting with the narrow surface of the plug terminal, sliding along the narrow surface toward the tail end, and finally resting on the narrow surface; the arcuate part contacting with the wide surface of the plug terminal, sliding along the narrow surface toward the tail end, and finally resting on the narrow surface.

2. The high-speed connector assembly as claimed in claim 1, wherein the L-type body and the bottom mounting portion of the differential signal socket terminal are located in a first vertical plane, but the front mating portion leaves the first vertical plane.

3. The high-speed connector assembly as claimed in claim 2, wherein the first branch is located in a second vertical plane and extends horizontally and straight ahead; and the arcuate part is located on a front end of the first branch, is formed by bending and is perpendicular to the second vertical plane; and
the second branch is located in a third vertical plane and extends horizontally and straight ahead; and the protrusion part is located on a front end of the second branch, is formed by stamping and is perpendicular to the third vertical plane.

4. The high-speed connector assembly as claimed in claim 3, wherein the second vertical plane is parallel to the first and third vertical planes, which are parallel or overlap.

5. The high-speed connector assembly as claimed in claim 1, wherein each pair of differential signal socket terminals includes two differential signal socket terminals, the front mating portions of which are symmetrical;
one grounding terminal is arranged above and below each pair of differential signal socket terminals; and a width of each grounding terminal is greater than that of each differential signal socket terminal.

6. A socket connector, comprising:
an insulating cover; and
multiple terminal modules, being arranged side by side and retained in the insulating cover; each terminal module including at least an insulating frame and a socket terminal group retained in the insulating frame; the socket terminal group including multiple pairs of differential signal socket terminals and multiple grounding terminals; wherein each of the differential signal socket terminals has an L-type body located in a first vertical plane, a front mating portion being bent from one end of the body toward one side of the body and extending forward, and a bottom mounting portion extending downward from the other end of the body; the bottom mounting portion being located in the first vertical plane, and the front mating portion leaving the first vertical plane;
wherein the front mating portion includes a first branch and a second branch, which are independent, noncoplanar, unequal-height and unequal-length; the first branch being located in a second vertical plane parallel to the first vertical plane and extending horizontally forward; the first branch having an arcuate part, which is formed by bending and is perpendicular to the second vertical plane, on a front end of the first branch; the second branch being located in a third vertical plane parallel to the second vertical plane extending horizontally forward; the second branch having a protrusion part, which is formed by stamping and is located in the third vertical plane, on a front end of the second branch;
when the socket connector is engaged with a plug connector, the arcuate part and the protrusion part can electrically contact with one wide surface and one narrow surface of a corresponding plug terminal, respectively.

7. The socket connector as claimed in claim 6, wherein a length of the second branch is greater than that of the first branch, and the protrusion part is located in front of the arcuate part.

8. The socket connector as claimed in claim 6, wherein each pair of differential signal socket terminals includes two differential signal socket terminals, the front mating portions of which are symmetrical;
one grounding terminal is arranged above and below each pair of differential signal socket terminals; and a width of each grounding terminal is greater than that of each differential signal socket terminal.

9. The socket connector as claimed in claim 6, wherein the first vertical plane and the third vertical plane are parallel or overlap.

10. A socket terminal, comprising:
an L-type body, being located in a first vertical plane;
a front mating portion, being bent from one end of the body toward one side of the body and extending forward; and
a bottom mounting portion, extending downward from the other end of the body;
the bottom mounting portion being located in the first vertical plane, and the front mating portion leaving the first vertical plane;
wherein the front mating portion includes a first branch and a second branch, which are independent, noncoplanar, unequal-height and unequal-length; the first branch being located in a second vertical plane parallel to the first vertical plane; the first branch having an arcuate part, which is formed by bending and is perpendicular to the second vertical plane for being used to electrically contact with one wide surface of a plug terminal; the second branch being located in a third vertical plane parallel to the second vertical plane; the second branch having a protrusion part, which is formed by stamping and is located in the third vertical plane for being used to electrically contact with one narrow surface of the plug terminal.

11. The socket terminal as claimed in claim 10, wherein a length of the second branch is greater than that of the first branch, and the protrusion part is located in front of the arcuate part.

12. The socket terminal as claimed in claim 10, wherein the first vertical plane and the third vertical plane are parallel or overlap.
